(19) United States
(12) Patent Application Publication
(10) Pub. No.: US 2010/0079236 A1
(43) Pub. Date: Apr. 1, 2010

(54) CONNECTION PARTNER DEVICE CONTROL APPARATUS AND CONNECTION PARTNER DEVICE CONTROL METHOD

(75) Inventor: Kazumasa OURA, Fukaya-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/492,702

(22) Filed: Jun. 26, 2009

(30) Foreign Application Priority Data
Sep. 29, 2008 (JP) 2008-251023

(51) Int. Cl. G05B 19/00

(52) U.S. Cl. 340/5.6

(57) ABSTRACT

According to one embodiment, a connection partner device control apparatus includes a reception module configured to receive a valid key codelist transmitted from a connection partner device, a storage module configured to store the valid key codelist, an information output module configured to output guide information used to guide operable keys based on the valid key codelist, an acceptance module configured to accept a key operation input, and a control module configured to check validity of the key operation accepted by the acceptance module based on the valid key codelist and to control the connection partner device based on the valid key operation.

### CROSS-REFERENCE TO RELATED APPLICATIONS

This application is based upon and claims the benefit of priority from Japanese Patent Application No. 2008-251023, filed Sep. 29, 2008, the entire contents of which are incorporated herein by reference.

### BACKGROUND

1. Field

One embodiment of the present invention relates to a connection partner device control apparatus such as a TV, which controls a connection partner device such as an HDD recorder via a High-Definition Multimedia Interface (HDMI)™, and a connection partner device control method applicable to such TV.

2. Description of the Related Art

In recent years, digital devices incorporating HDMI, for example, TVs, DVD players, and DVD recorders, have prevailed. HDMI can transfer non-compressed video and audio data. When devices declaring HDMI-Consumer Electronics Control (CEC) compatibility, e.g., a TV and DVD recorder, are connected via HDMI, the HDMI-CEC function allows operation of the DVD recorder using a remote controller of the TV.

Furthermore, Jpn. Pat. Appln. KOKAI Publication No. 2008-109341 (reference 1) discloses a technique which connects a television receiver and portable phone using HDMI. According to this technique, the portable phone can control the operation of the TV by HDMI-CEC, and can be used as a remote controller of the TV.

Jpn. Pat. Appln. KOKAI Publication No. 2007-60658 (reference 2) discloses a technique associated with a remote controller which controls a plurality of source input devices, and a video output device and audio output device connected to this plurality of source input devices. According to this technique, key code values of a plurality of external input channels are set for the video output device and audio output device, and when the remote controller transmits a predetermined signal, a signal from a predetermined source input device is output from the video output device and audio output device.

Reference 1 describes the portable phone that can be used as the remote controller of the TV via the HDMI-CEC function. However, not all the keys of the portable phone are valid to control the operation of the TV. That is, the portable phone includes some keys that are invalid upon controlling the operation of the TV. However, the user cannot easily discriminate valid and invalid keys on the remote controller, resulting in inconvenience.

Reference 2 describes the remote controller which controls a plurality of devices. In this case as well, not all the keys on the remote controller are valid, and the remote controller includes some invalid keys. Also, a predetermined key on the remote controller may or may not be valid depending on a partner device to be controlled. However, the user cannot easily discriminate these keys, resulting in inconvenience.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic block diagram showing the arrangement of a digital television broadcast receiving apparatus (connection partner device control apparatus) according to an embodiment of the invention;

FIG. 2 is a flowchart for explaining management of a key codelist by the digital television broadcast receiving apparatus according to the embodiment;

FIG. 3 is a view showing a key codelist request command according to the embodiment;

FIG. 4 is a view showing a key codelist transmission command according to the embodiment;

FIG. 5 is a view showing a prescribed key codelist according to the embodiment;

FIG. 6 is a view showing on-screen display information (first display example) used to guide operable keys according to the embodiment; and

FIG. 7 is a view showing on-screen display information (second display example) used to guide operable keys according to the embodiment.

### DETAILED DESCRIPTION

Various embodiments according to the invention will be described hereinafter with reference to the accompanying drawings. In general, a connection partner device control apparatus according to one embodiment of the invention comprises: a reception module configured to receive a valid key codelist transmitted from a connection partner device; a storage module configured to store the valid key codelist; an information output module configured to output guide information used to guide operable keys based on the valid key codelist; an acceptance module configured to accept a key operation input; and a control module configured to check validity of the key operation accepted by the acceptance module based on the valid key codelist and to control the connection partner device based on the valid key operation.

Embodiments of the invention will be described hereinafter with reference to the drawings.

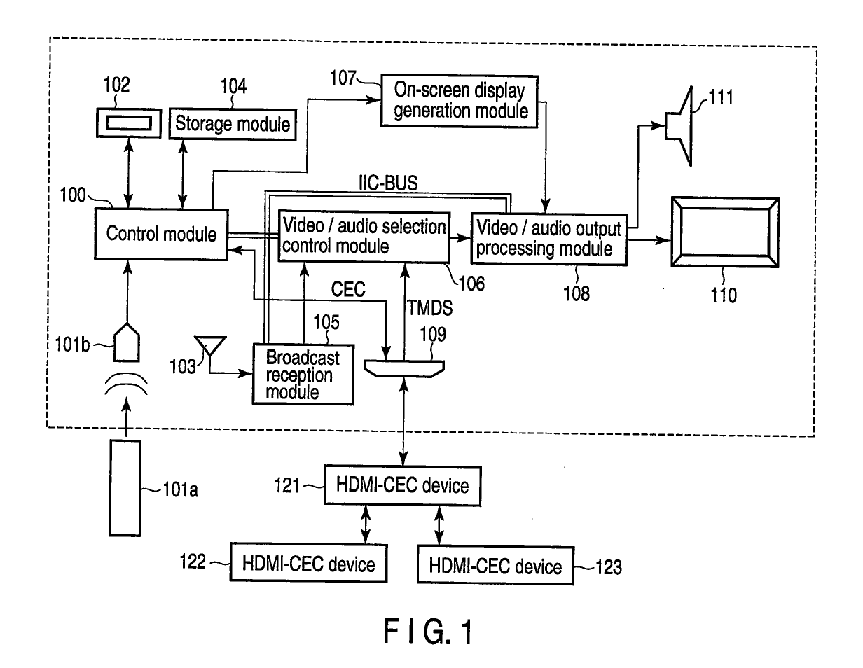

FIG. 1 is a schematic block diagram showing the arrangement of a digital television broadcast receiving apparatus (connection partner device control apparatus) according to an embodiment of the invention. The digital television broadcast receiving apparatus will be described below with reference to FIG. 1.

This digital television broadcast receiving apparatus includes an HDMI connection module 109, and can connect a plurality of connection partner devices having HDMI terminals. As shown in FIG. 1, a TV and specific connection partner device are connected, and the TV can be connected to other connection partner devices via this specific connection partner device. Or the HDMI connection module 109 of the TV includes a plurality of HDMI terminals, and the TV and a plurality of connection partner devices having HDMI terminals can be connected via this plurality of HDMI terminals. Furthermore, this TV complies with HDMI-CEC, and can control connection partner devices using the HDMI-CEC function.

As shown in FIG. 1, a broadcast transmission signal is input to a broadcast reception module 105 via a reception antenna 103. The broadcast reception module 105 tunes a signal of one channel from signals of a plurality of channels included in the broadcast transmission signal. Video and audio signals included in the tuned signal of one channel are input to a video/audio selection control module 106. Also, video and audio signals from a connection partner device such as a DVD recorder connected via the HDMI connection module 109 are also input to the video/audio selection control module 106. Input signals input to the video/audio selection control module 106 are managed by a control module 100.

An operation signal from a remote controller 101a is received by a code reception module 101b, and is decoded by the control module 100. For example, when the code reception module 101b receives a desired channel tuning or desired input select operation signal, the control module 100 controls the video/audio selection control module 106 based on the received operation signal.

Assume that connection partner devices (HDMI-CEC devices) 121, 122, and 123 are connected via the HDMI connection module 109. An LCD panel 110 displays the names (identification information) of the connection partner devices 121, 122, and 123 as input selection candidates. When the name of the connection partner device 121 is selected in response to a cursor operation or an operation of an input select button via the remote controller, the control module 100 controls the video/audio selection control module 106 to select video and audio signals from the connection partner device 121. As a result, the video/audio selection control module 106 outputs the video and audio signals from the connection partner device 121. Likewise, when the name of the connection partner device 122 is selected in response to a cursor operation or the like via the remote controller, the video/audio selection control module 106 outputs video and audio signals from the connection partner device 122. When the name of the connection partner device 123 is selected, the video/audio selection control module 106 outputs video and audio signals from the connection partner device 123.

The control module 100 controls an on-screen display generation module 107 to make it generate predetermined on-screen display information. For example, the control module 100 controls to generate on-screen display information used to guide valid keys (operable keys) for the selected connection partner device based on a key codelist stored in a storage module 104. The on-screen display information generated by the on-screen display generation module 107 is input to a video/audio output processing module 108. The video/audio output processing module 108 superimposes the on-screen display information on a video signal from the video/audio selection control module 106. As a result, the LCD panel 110 displays a video on which the on-screen display information is superimposed.

The control module 100 controls the output tone volume from a loudspeaker 111. That is, the video/audio output processing module 108 adjusts the tone volume of an audio based on the tone volume control from the control module 100.

Furthermore, the control module 100 can make two-way communication with the connection partner devices 121, 122, and 123 using HDMI-CEC via the HDMI connection module 109.

Moreover, the control module 100 can connect a connection partner device via a USB terminal 102.

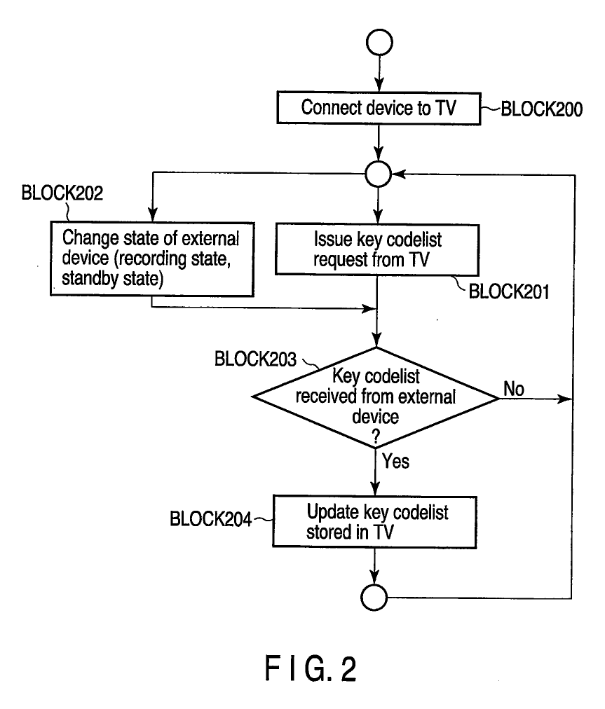

Display control of guide information used to guide operable keys by the digital television broadcast receiving apparatus will be described below with reference to the flowchart shown in FIG. 2.

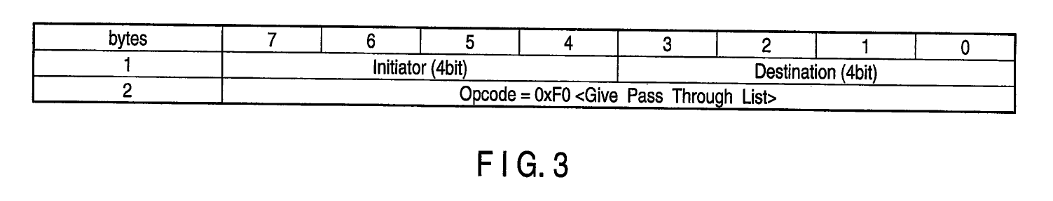

For example, if the digital television broadcast receiving apparatus and connection partner device 121 are connected via the HDMI connection module 109 (BLOCK 200), and the control module 100 determines that a data communication can be made with the connection partner device 121, the control module 100 requests the connection partner device 121 to send a valid/invalid key codelist (BLOCK 201). For example, the control module 100 requests the valid/invalid key codelist using a key codelist request command shown in FIG. 3. The key codelist request command shown in FIG. 3 is a command complying with the HDMI-CEC protocol (predetermined communication protocol).

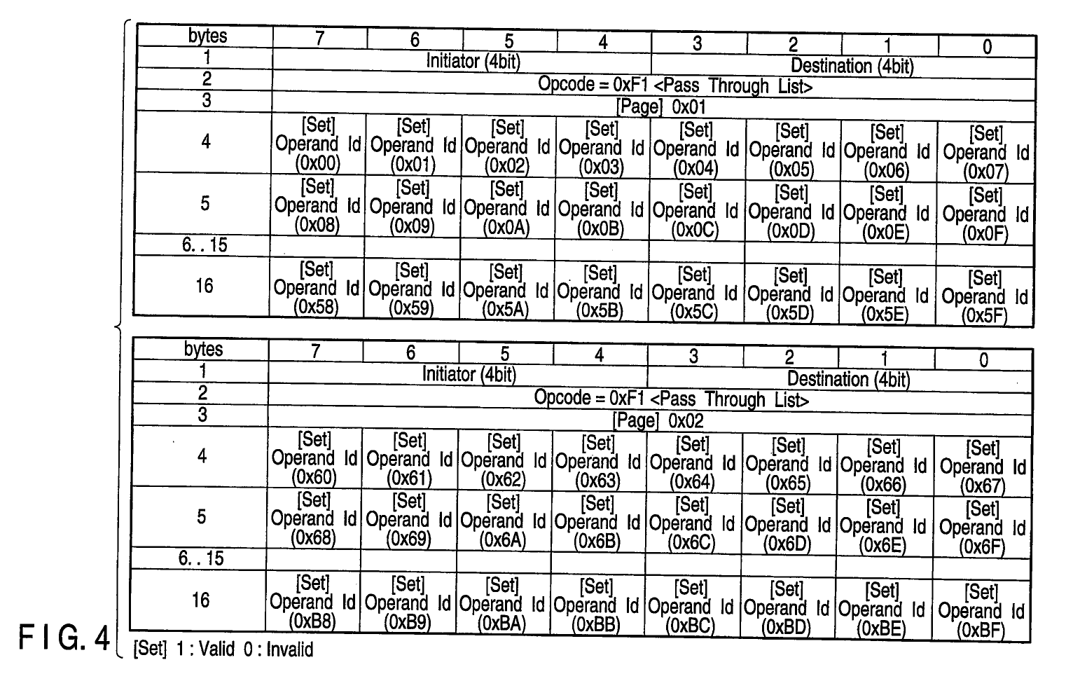

The connection partner device 121 receives the key codelist request command from the digital television broadcast receiving apparatus, and transmits a key codelist transmission command to the digital television broadcast receiving apparatus. FIG. 4 is a view showing an example of the key codelist transmission command. The key codelist transmission command transmitted from the connection partner device 121 includes a valid/invalid key codelist, and is configured by, for example, 16 bytes+16 bytes.

Upon reception of the valid/invalid key codelist (key codelist transmission command) transmitted from the connection partner device 121 in response to the above request (YES in ST203), the control module 100 stores the valid/invalid key codelist from the connection partner device 121 in the storage module 104 (BLOCK 204). If the valid/invalid key codelist from the connection partner device 121 has already been stored in the storage module 104, the stored valid/invalid key codelist is updated by the latest valid/invalid key codelist received from the connection partner device 121. Note that the storage module 104 need only store at least the latest valid/invalid key codelist, and the previously received valid/invalid key codelist may be left.

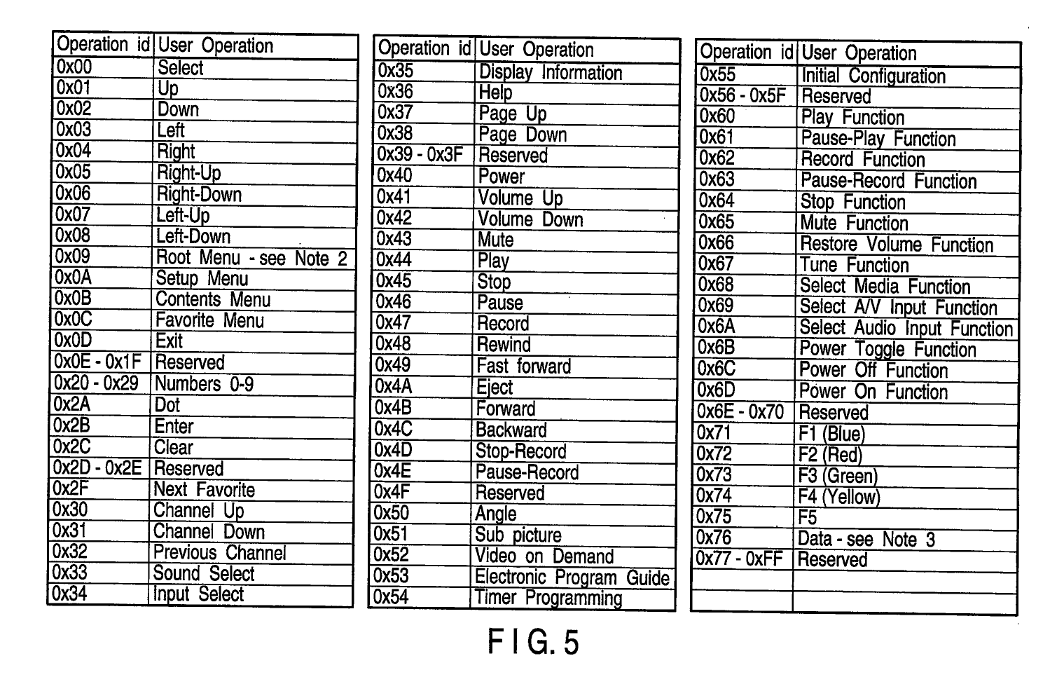

The storage module 104 stores, in advance, a CEC table 27 specified by the HDMI-CEC protocol. FIG. 5 is a view showing an example of the CEC table 27. The CEC table 27 is a prescribed key codelist, and includes definition information of respective keys. That is, the prescribed key codelist is a list indicating user operations corresponding to respective operation IDs.

As can be seen from the comparison between the prescribed key codelist shown in FIG. 5 and the valid/invalid key codelist included in the key codelist transmission command shown in FIG. 4, these lists correspond to each other. That is, the prescribed key codelist describes user operations corresponding to respective operation IDs (0x00, 0x01, . . . ), and the valid/invalid key codelist describes information indicating validity/invalidity (bit 1/bit 0) corresponding to respective operation IDs (0x00, 0x01, . . . ). That is, the valid/invalid key codelist includes information (bit 1/bit 0) indicating valid or invalid keys (operation IDs). In this way, by adopting the valid/invalid key codelist corresponding to the prescribed key codelist, the number of commands can be reduced.

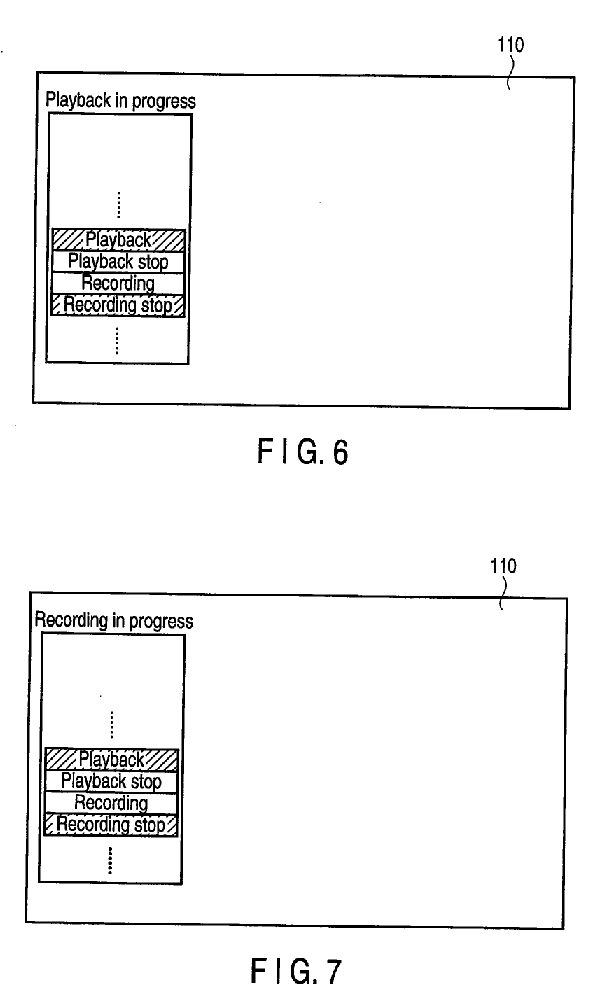

The control module 100 determines valid and invalid keys with reference to the prescribed key codelist and the valid/invalid key codelist, and the on-screen display generation module 107 generates on-screen display information used to guide operable keys. FIGS. 6 and 7 are views showing display examples of the on-screen display information used to guide operable keys. As shown in FIGS. 6 and 7, the LCD panel 110 displays valid and invalid keys on the remote controller while being color-coded. For example, valid keys (a playback stop key and recording key in FIG. 6, and a playback key and recording stop key in FIG. 7) are displayed to have light tone, and invalid keys (a playback key and recording stop key in FIG. 6, and a playback stop key and recording key in FIG. 7) are displayed to have dark tone. Alternatively, only valid keys on the remote controller may be displayed. In this manner, using a graphical user interface (GUI), the user can easily recognize valid and invalid keys on the remote controller.

When the user inputs a key operation via the remote controller 101a, the control module 101a accepts the key operation input, determines the validity of the accepted key operation with reference to the prescribed key codelist and valid/invalid key codelist, and controls the connection partner device 121 based on the valid key operation.

A guide display of operable keys in correspondence with a change in operation state of the connection partner device will be described below. For example, if the connection partner device 121 is a DVD recorder, and is in a standby state, it can start a playback operation or recording operation. However, when the playback operation of the connection partner device 121 is in progress, the playback operation cannot be started but it can be stopped, and a recording operation can be started. When the recording operation of the connection partner device 121 is in progress, the recording operation cannot be started but it can be stopped, and a playback operation can be started.

In this manner, operable keys are different depending on the operation state of the connection partner device. The control module 100 of the digital television broadcast receiving apparatus can monitor the operation state of the connection partner device 121 by HDMI-CEC. That is, the control module 100 can detect a change in operation state of the connection partner device 121 by HDMI-CEC. Upon detection of a change in operation state, the control module 100 requests the connection partner device 121 to transmit the valid/invalid key codelist. The connection partner device 121 transmits the valid/invalid key codelist according to its operation state. As a result, the digital television broadcast receiving apparatus can acquire the latest valid/invalid key codelist according to the operation state of the connection partner device 121. That is, the digital television broadcast receiving apparatus can guide operable keys according to the operation state of the connection partner device 121.

For example, when the control module 100 detects that the playback operation of the connection partner device 121 is in progress, and acquires the latest valid/invalid key codelist according to this operation state, the apparatus can guide operable keys based on the latest valid/invalid key codelist according to the operation state, as shown in FIG. 6. That is, as shown in FIG. 6, the LCD panel 110 displays a message “playback in progress”, and also displays that the playback key is invalid, the playback stop key is valid, the recording key is valid, and the recording stop key is invalid.

Or when the control module 100 detects that the recording operation of the connection partner device 121 is in progress, and acquires the latest valid/invalid key codelist according to this operation state, the apparatus can guide operable keys based on the latest valid/invalid key codelist according to the operation state, as shown in FIG. 7. That is, as shown in FIG. 7, the LCD panel 110 displays a message “recording in progress”, and also displays that the playback key is valid, the playback stop key is invalid, the recording key is invalid, and the recording stop key is valid.

Furthermore, when the guide display of operable keys is updated upon detection of a change in operation state of the connection partner device, the on-screen display generation module 107 notifies the user of the updated guide display of operable keys by flashing the guide display of operable keys or displaying an icon indicating that the guide display is updated, under the control of the control module 100. Or the video/audio output processing module 108 outputs an alarm sound indicating that the guide display of operable keys is updated, under the control of the control module 100. As described above, various modes of the notification indicating that the guide display of operable keys is updated are available, and the user can easily recognize based on the notification that operable keys are updated, and the operation state of the connection partner device has changed.

Note that the case has been explained wherein the digital television broadcast receiving apparatus serves as a main body, and issues the valid/invalid key codelist request. Alternatively, the connection partner device may serve as a main body, and may transmit the valid/invalid key codelist. In this case as well, the digital television broadcast receiving apparatus may store at least the latest valid/invalid key codelist from the connection partner device 121.

As shown in FIG. 1, when the digital television broadcast receiving apparatus is connected to the connection partner device 121, 122, and 123 via the HDMI connection module 109, it issues valid/invalid key codelist requests to the connection partner devices 121, 122, and 123, respectively. As a result, the digital television broadcast receiving apparatus can store the valid/invalid key codelists from the connection partner devices 121, 122, and 123. For example, when the user selects the connection partner device 121 via the remote controller 101a, operable keys with respect to the connection partner device 121 are on-screen displayed. When the user selects the connection partner device 122, operable keys with respect to the connection partner device 122 are on-screen displayed. When the user selects the connection partner device 123, operable keys with respect to the connection partner device 123 are on-screen displayed. When the operation state of each of the connection partner devices 121, 122, and 123 changes, the on-screen display also switches according to the operation state.

As described above, since the digital television broadcast receiving apparatus on-screen displays operable keys in correspondence with the state of the connection partner device, the user can visually recognize operable keys.

The various modules of the device described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A connection partner device control apparatus comprising:
a reception module configured to receive a valid key codelist transmitted from a connection partner device;
a storage module configured to store the valid key codelist;
an information output module configured to output guide information used to guide operable keys based on the valid key codelist;
an acceptance module configured to accept a key operation input; and
a control module configured to check validity of the key operation accepted by the acceptance module based on the valid key codelist and to control the connection partner device based on the valid key operation.

2. The apparatus of claim 1, wherein the reception module receives the valid key codelist transmitted from the connection partner device,
the storage module stores at least a latest valid key codelist, and
the information output module generates latest guide information based on the latest valid key codelist, and updates the guide information, which is being output, by the latest guide information.

3. The apparatus of claim 2, wherein the control module checks the validity of the key operation accepted by the acceptance module based on the latest valid key codelist, and controls the connection partner device based on the valid key operation.

4. The apparatus of claim 3, which further comprises:
an operation state monitor module configured to monitor an operation state of the connection partner device; and
a request module configured to request the latest valid key codelist based on a change in operation state of the connection partner device detected by the operation state monitor module, and
in which the reception module receives the latest valid key codelist transmitted from the connection partner device.

5. The apparatus of claim 2, wherein the information output module outputs information indicating that the guide information, which is being output, is updated by the latest guide information.

6. The apparatus of claim 1, wherein the information output module outputs graphics used to guide the operable keys based on the valid key codelist.

7. The apparatus of claim 1, wherein the storage module stores a prescribed key codelist specified by a predetermined communication protocol,
the reception module receives the valid key codelist corresponding to the prescribed key codelist,
the prescribed key codelist includes definition information of respective keys,
the valid key codelist includes information indicating validity of respective keys, and
the control module checks the validity of the key operation accepted by the acceptance module with reference to the prescribed key codelist and the valid key codelist, and controls the connection partner device based on the valid key operation.

8. The apparatus of claim 1, further comprising a tuning module configured to tune to, based on a tuning key operation accepted by the acceptance module, a signal designated by the tuning key operation from a received broadcast signal.

9. A connection partner device control method comprising:
receiving a valid key codelist transmitted from a connection partner device;
storing the valid key codelist;
outputting guide information used to guide operable keys based on the valid key codelist;
accepting a key operation input; and
checking validity of the accepted key operation based on the valid key codelist and controlling the connection partner device based on the valid key operation.

10. A connection partner device control apparatus comprising:
a display module configured to display a video;
an acceptance module configured to accept a key operation input;
a control module configured to control a connection partner device based on the key operation accepted by the acceptance module; and
an information output module configured to make the display module display information corresponding to a changed operation state in accordance with a change in operation state of the connection partner device.
